(19) United States
(12) Patent Application Publication
(10) Pub. No.: US 2019/0012943 A1
(43) Pub. Date: Jan. 10, 2019

(54) LIGHTER THAN AIR MONITORING DEVICE AND ADVERTISEMENT PLATFORM

(71) Applicant: POINTR DATA INC., San Jose, CA (US)

(72) Inventors: Nurettin Burcak Beser, Palo Alto, CA (US); Saran Saund, Mountain View, CA (US)

(21) Appl. No.: 16/029,475

(22) Filed: Jul. 6, 2018

Related U.S. Application Data
(60) Provisional application No. 62/529,971, filed on Jul. 7, 2017.

(51) Int. Cl. G09F 21/10; B64B 1/42; G09F 19/18; B64D 47/08; G03B 15/00

(52) U.S. Cl. CPC G09F 21/10; B64B 1/42; G03B 15/006; B64D 47/08; G09F 19/18

(57) ABSTRACT

An air monitoring device includes a main body defining a volume for receiving a gas and configured to move above a ground surface. The air monitoring device further includes a camera configured to detect image data corresponding to a surrounding environment of the main body. The air monitoring device further includes a power source configured to generate mechanical power to propel the main body through the surrounding environment. The air monitoring device further includes a network access device configured to communicate with a remote device. The air monitoring device further includes a processor configured to receive the image data and to cause the network access device to transmit the image data or processed data corresponding to the image data to the remote device.

### PRIORITY

This application claims the benefit and priority of U.S. Provisional Application No. 62/529,971, entitled “LIGHTER THAN AIR MONITORING DEVICE AND ADVERTISEMENT PLATFORM,” filed on Jul. 7, 2017, the entire disclosure of which is hereby incorporated by reference herein in its entirety.

### FIELD

The present disclosure relates to systems and methods for monitoring an indoor or outdoor area from an elevated perspective and, more particularly, to systems and methods for air monitoring by an air monitoring device having a relatively light weight.

### DESCRIPTION OF THE RELATED ART

Indoor imaging can serve multiple purposes such as observing customer behavior, monitoring an inventory of products, monitoring for theft, and the like. Many stores include indoor cameras located on the ceiling for capturing a birds eye view of the interior of the store. However, such cameras are insufficient for detecting information such as whether shelves require restocking, whether a hazard exists in the store, or the like.

Recently, some stores have introduced moving robots that include cameras for detecting such information. However, such robots may present problems. For example, as the robots stroll aisles, they may come into contact with customers, causing harm to the customers or causing damage to the robots. Additionally, some customers may try to play with the robots, either deprogramming the robot, preventing it from completing its route, or damaging the robot.

Thus, there is a need in the art for systems and methods for aerial monitoring of indoor and outdoor locations.

### SUMMARY

Described herein is an air monitoring device. The air monitoring device includes a main body defining a volume for receiving a gas and designed to move above a ground surface. The air monitoring device further includes a camera designed to detect image data corresponding to a surrounding environment of the main body. The air monitoring device further includes a power source designed to generate mechanical power to propel the main body through the surrounding environment. The air monitoring device further includes a network access device designed to communicate with a remote device. The air monitoring device further includes a processor designed to receive the image data and to cause the network access device to transmit the image data or processed data corresponding to the image data to the remote device.

Also disclosed is an air monitoring device. The air monitoring device includes a main body defining a volume for receiving a gas and designed to move above a ground surface. The air monitoring device further includes a cartridge designed to store compressed gas. The air monitoring device further includes a cartridge valve located between the cartridge and the volume defined by the main body. The air monitoring device further includes a camera designed to detect image data corresponding to a surrounding environment of the main body. The air monitoring device further includes a network access device designed to communicate with a remote device. The air monitoring device further includes a processor designed to receive the image data, to cause the network access device to transmit the image data or processed data corresponding to the image data to the remote device, and to control the cartridge valve to allow the compressed gas to flow from the cartridge to the volume to increase buoyancy of the main body.

Also disclosed is a system for air monitoring. The system includes at least one wire or cable suspended above a ground surface. The system also includes an air monitoring device. The air monitoring device includes a main body defining a volume for receiving a gas and designed to be coupled to the at least one wire or cable. The air monitoring device further includes a camera designed to detect image data corresponding to a surrounding environment of the main body. The air monitoring device further includes an actuator designed to move the main body along the at least one wire or cable. The air monitoring device further includes a network access device designed to communicate with a remote device. The air monitoring device further includes a processor designed to receive the image data and to cause the network access device to transmit the image data or processed data corresponding to the image data to the remote device.

### BRIEF DESCRIPTION OF THE DRAWINGS

The accompanying drawings illustrate various embodiments employing the principles described herein and are a part of the specification. The illustrated embodiments are meant for description only, and they do not limit the scope of the claims, and in which:

FIG. 1 is a block diagram illustrating an air monitoring system including an air monitoring device for monitoring an indoor or outdoor area according to an embodiment of the present disclosure;

FIG. 2A is a drawing illustrating an exemplary air monitoring device according to an embodiment of the present disclosure;

FIG. 2B is a drawing illustrating another exemplary air monitoring device according to an embodiment of the present disclosure;

FIG. 3 is a drawing of a system including a network of wires or cables and an air monitoring device designed to travel along the network of wires or cables according to an embodiment of the present disclosure; and

FIGS. 4A and 4B are flowcharts illustrating an exemplary method for monitoring an indoor or outdoor location by an air monitoring system according to an embodiment of the present disclosure.

### DETAILED DESCRIPTION

This detailed description of exemplary embodiments references the accompanying drawings, which show exemplary embodiments by way of illustration. While these exemplary embodiments are described in sufficient detail to enable those skilled in the art to practice this disclosure, it should be understood that other embodiments may be realized and that logical changes and adaptations in design and construction may be made in accordance with this disclosure and the teachings herein described without departing from the scope and spirit hereof. Thus, this detailed description is presented for purposes of illustration only and not of limitation.

Described herein are devices, systems, and methods for monitoring indoor and outdoor venues. The systems and methods may be used, for example, to monitor inventory of shelves of a store, to monitor for hazardous situations, to advertise or provide other information, to provide emergency lighting, and the like. The devices may be relatively buoyant, allowing them to detect data from an elevated vantage point while using relatively little energy to move between locations. In some situations, the devices may be lighter than air, or may be relatively weight neutral, further reducing energy usage of the devices. The devices may be capable of adjusting their buoyancy based on detected changes in buoyancy to further reduce energy usage.

The devices may include sensors and may transmit detected data (or processed data) to a remote device, such as an edge or cloud network, for processing. In some embodiments, the edge or cloud network may be an artificial neural network and may perform an artificial intelligence algorithm using the detected data to analyze the status of the area being monitored. The edge or cloud network (or processor of the device) may output useful information such as relevant advertisements, warnings of potential hazards, or whether a shelf is out of product or nearly out of product. The processor of the device (or the edge or cloud network) may also determine whether a better point of view would be helpful (e.g., whether a particular view of the camera is impeded) and may control the device to change locations to improve the data collection.

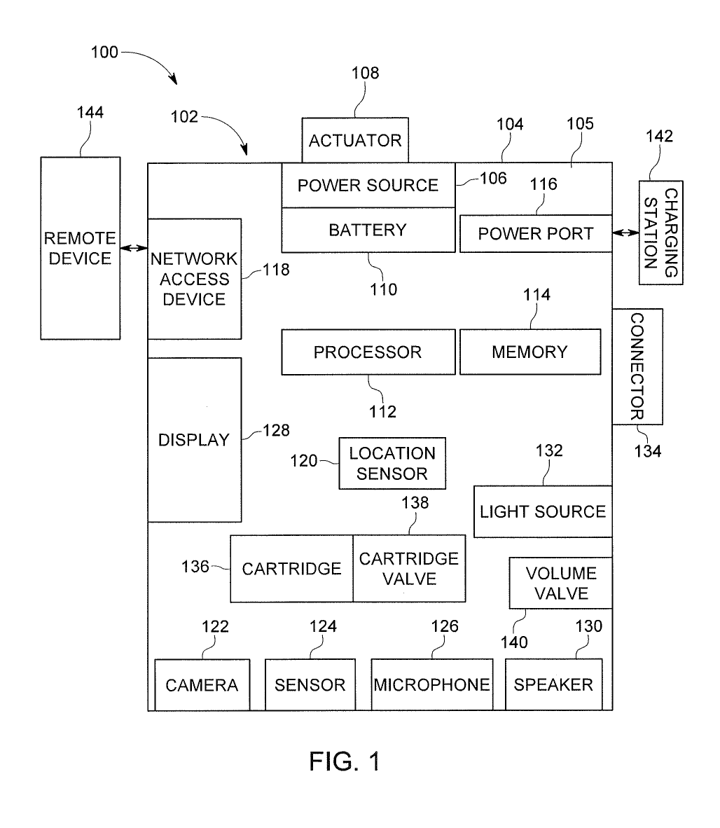

Referring now to FIG. 1, a system 100 for air monitoring of an indoor or outdoor space may include an air monitoring device, or device, 102. The air monitoring device 102 may include a main body 104 that defines a volume 105. In some embodiments, the main body 104 may be airtight such that gas is retained within the volume 105 and cannot leak through the main body 104.

The device 102 may include at least one power source 106 and at least one actuator 108. In some embodiments, the power source 106 and actuator 108 may be a single combined component and in some embodiments, the power source 106 and actuator 108 may be separate components. For example, the power source 106 may include a motor, an engine, or the like. The actuator may include, for example, one or more propeller, a linear actuator, a rotary actuator, a chain actuator, or the like.

In some embodiments, the power source 106 and actuator 108 may be designed to be capable of moving the main body 104 in any direction (forward, aft, left, right, up, and down) based on instructions received from the processor 112.

In some embodiments, the device 102 may include a battery 110. The battery 110 may store electrical energy that may be used by the power source 106. In that regard, the battery 110 may include a battery or other energy storage device such as a supercapacitor. For example, if the power source 106 is a motor, the motor may convert electrical energy stored in the battery 110 into mechanical power that is used by the actuator 108 to propel the device 102.

The device 102 may further include a processor 112 and a memory 114. The processor 112 may include any logic device such as one or more of a central processing unit (CPU), an accelerated processing unit (APU), a digital signal processor (DSP), a field programmable gate array (FPGA), an application specific integrated circuit (ASIC), or the like. The processor 112 may communicate with some or all of the components of the device 102. The memory 114 may include any non-transitory memory known in the art. The memory may store, for example, data as instructed by the processor 112, instructions usable by the processor 112 to perform operations as described herein, or the like.

The device 102 may further include a power port 116. The power port 116 may be in electrical communication with the battery 110. In that regard, the power port 116 may receive electrical energy from a charging station 142. The power port 116 may be designed to receive electrical energy wirelessly or via a contact, plug, or other physical connection. For example, the power port 116 may be designed to receive an electrical charge via radio charging, inductive charging, resonance charging, contact pads, a physical plug, or the like. In that regard, the charging station 142 may be designed to transmit power in such a way that the power port 116 may receive the power provided by the charging station 142.

The device 102 may further include a network access device 118. The network access device 118 may communicate via any wired or wireless protocol such as a CAN bus protocol, an Ethernet physical layer protocol (e.g., those using 10BASE-T, 100BASE-T, 1000BASE-T, etc), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH protocol maintained by Bluetooth Special Interest Group), a wireless communications protocol defined at least in part by IEEE 802.15.4 (e.g., the ZigBee protocol maintained by the ZigBee alliance), a cellular protocol, an infrared protocol, an optical protocol, or any other protocol capable of transmitting information via a wired or wireless connection.

The device 102 may include a plurality of sensors. For example, the device 102 may include any one or more of a location sensor 120, a camera 122, a sensor 124, or a microphone 126.

The location sensor 120 may include, for example, one or more of an inertial measurement unit (IMU), a global positioning system (GPS) sensor, a radar sensor, a LIDAR sensor, or the like. In some embodiments, the processor 112 may determine a current location of the main body 104 based on data detected by the location sensor 120. In some embodiments, the processor 112 may determine the current location of the main body 104 based on data detected by the network access device 118. For example, the processor 112 may determine the current location of the main body 104 based on Wi-Fi or Bluetooth signals detected by the network access device 118.

The camera 122 may include any one or more camera capable of detecting image data in a surrounding environment of the main body 104. For example, the camera 122 may include a standard digital camera, a wide view camera, a stereo pair of cameras capable of detecting depth data, or the like. In some embodiments, the camera 122 may include an actuator capable of adjusting an orientation of the camera 122. In that regard, the processor 112 may control the actuator of the camera 122 to orient the camera 122 to detect image data corresponding to a specific location. In some embodiments, the camera 122 may be focused by the processor to clearly detect image data corresponding to a specific location. In some embodiments, the processor 112 (or a remote device 144) may be capable of detecting a current location of the main body 104 based on the detected image data.

The sensor 124 may include any other sensor capable of detecting data corresponding to the environment of the main body 104. For example, the sensor 124 may include an optical fire sensor, a smoke detector, or other sensor capable of detecting a fire or smoke in the environment of the main body 104. As another example, the sensor 124 may be capable of detecting a gas or other chemicals in the environment of the main body 104. For example, the sensor 124 may be capable of detecting chemicals used in weapons of mass destruction, viruses, bacteria, or the like. In that regard, the device 102 may be deployed in an airport, a concert, or other heavily populated event and may be used to detect potential explosive devices or other hazardous materials. As another example, the sensor 124 may include an ultrasonic sensor, a laser distance sensor, or the like.

The microphone 126 may include any microphone capable of detecting audio data. In that regard, the microphone 126 may detect audio in the environment of the main body 104.

The processor 112 may analyze the data detected by the sensors and may perform actions based on the analysis of the data. The processor 112 may further control the network access device 118 to transmit the detected data, or a processed version of the detected data, to a remote device 144. The remote device 144 may be a part of an artificial neural network and may perform one or more artificial intelligence algorithm. In that regard, the remote device 144 may receive the detected data, or the processed version of the detected data, and may analyze the detected data to determine information. For example, the remote device 144 (or the processor 112) may determine whether shelves of a store require restocking, whether a product is located in a wrong location, whether a hazardous situation is present (such as liquid spilled on a floor, a fire, etc.), whether shoplifting is occurring, or the like.

The device 102 may include one or more output device including one or more of a display 128, a speaker 130, or a light source 132. The display 128 may include any digital or analog display. For example, the display 128 may include a liquid crystal display (LCD), an e-ink display, a projector (such as a digital light processing (DLP) projector), or the like. For example, the projector may display information on the main body 104 or on a surface in an environment of the main body 104.

The speaker 130 may include any one or more speaker capable of outputting audio data.

The light source 132 may include any light source capable of emitting light. For example, the light source 132 may include an incandescent bulb, a light emitting diode (LED), or the like.

The processor 112 may control one or more of the output devices based on at least one of programmed instructions, data detected by one or more sensor, or information received from the remote device 144. For example, the processor 122 (or the remote device 144) may control the display 128 to display certain information based on data detected by the camera 122 or the location sensor 120.

In some embodiments, the remote device 144 may transmit instructions to the processor 112 based on the analysis of the detected data. For example, the remote device 144 (or the processor 112) may identify a current aisle in a store in which the main body 104 is located, may determine which products are available in the aisle, and may control the display 128 to display advertisements related to the products available in the aisle. As another example, the remote device 144 (or the processor 112) may identify characteristics of individuals in the environment of the main body 104 and may control the display 128 or the speaker 130 to output information (such as advertisements) based on the characteristics of the individuals. For example, if the image data indicates that a mother with a baby present, the remote device 144 (or the processor 112) may control the display 128 to display an advertisement for baby products. As another example, the remote device 144 (or the processor 112) may identify a hazard (such as a fire or a spill) and may control one or more of the microphone 126 or the speaker 130 to output data warning of the hazard, or may control the network access device 118 to transmit data to a third party informing the third party of the hazard. As another example, the remote device 144 (or the processor 112) may identify that power has been lost in an indoor location and may control the light source 132 to generate light to illuminate the location. As another example, the remote device 144 (or the processor 112) may identify whether a relatively large number of people congregate around a specific product at any given time, and may transmit a message with information that the product should be given more shelf space.

The device 102 may further include a connector 134. The connector 134 may be a physical connector and may allow the device 102 to mechanically connect to a wire or cable, or network of wires or cables, suspended in an indoor or outdoor area. In that regard, the actuator 108 may move the device along the wire or cable, or network of wire or cables.

In some embodiments, the connector 134 may be used to connect a banner or other physical advertisement to the main body 104.

The device 102 may further include a cartridge 136, a cartridge valve 138, and a volume valve 140. The cartridge 136 may store a compressed gas, such as helium, which may be lighter than air. In that regard, the processor 112 may control the cartridge valve 138 to allow some or all of the compressed gas to move from the cartridge 136 into the volume 105 to increase buoyancy of the main body 104. In a similar manner, the processor 112 may control the volume valve 140 to release gas from the volume 105 in order to decrease buoyancy or, if compressed gas is simultaneously being released from the cartridge 136, to increase buoyancy (e.g., by replacing air in the volume 105 with helium). In that regard and in some embodiments, the processor 112 may control the volume valve 142 to release gas (such as air) from the volume 105 while simultaneously allowing the cartridge valve 138 to release compressed gas (such as helium) into the volume 105 in order to increase buoyancy.

In some embodiments, the device 102 may be used in situations other than monitoring, such as for taking video of sporting events. Because the device 102 may be relatively buoyant neutral, the device may be able to remain hovering in the air while using relatively little energy. Furthermore, because the device uses relatively little energy, the power source 106 and actuator 108 may make relatively little noise, thus causing little disruption to any players or bystanders, and allowing relatively clear audio data to be detected.

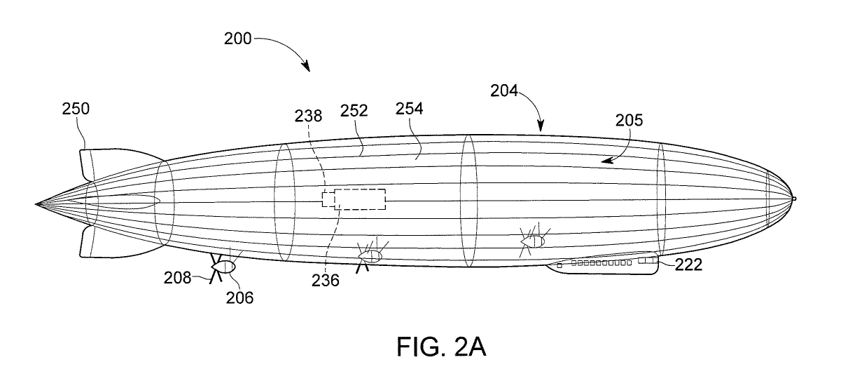

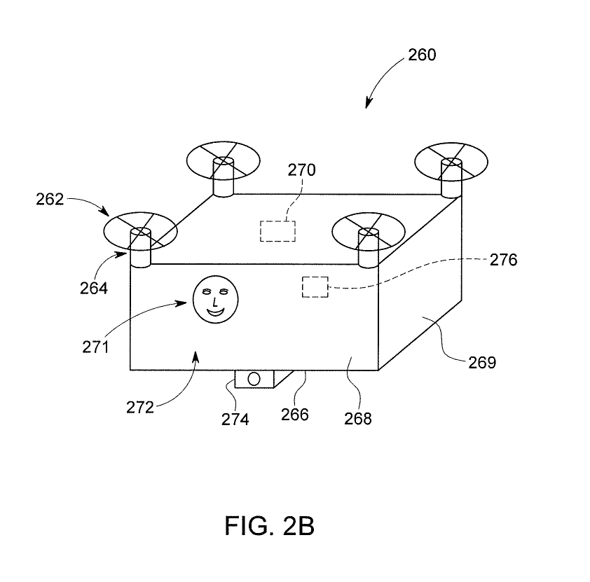

Turning now to FIG. 2A, an exemplary air monitoring device 200 is shown. The device 200 includes a main body 204 that defines a volume 205. The main body 204 includes a frame 252 surrounded by an airproof material 254. For example, the frame 252 may include a lightweight material such as a carbon fiber composite, aluminum, or the like. The airproof material 254 may include any airproof material that surrounds the frame 252. For example, the airproof material 254 may include rubber, Mylar, or the like. In some embodiments, the airproof material may be expandable such that a total size of the main body 204 expands as gas is released into the volume 205.

In some embodiments, the airproof material 254 may be reflective, or may include a reflective portion. In that regard, an image may be projected onto the reflective portion of the airproof material 254 from a projector of the device 202 or from a projector within an environment of the device 202.

The device 200 may further include a cartridge 236 along with a cartridge valve 238. The cartridge valve 238 may allow compressed gas stored in the cartridge 236 to be released into the volume 205. In some embodiments, release of the compressed gas into the volume 205 may expand the material 254, thus expanding the size of the volume 205.

The device 200 may further include a camera 222. The camera 222 may be designed to detect image data in an environment of the device 200.

The device 200 may further include a motor 206 coupled to a propeller 208. The motor 206 may generate mechanical power which is used to power the propeller 208, thus propelling the device 200 through an environment.

The device 200 may further include one or more rudder 250. The rudder 250 may be adjusted to control a flight path of the device 200. For example, a processor may control the motor 206, the propeller 208, and the rudder 252 to cause the device 200 to fly in a desired direction and at a desired altitude. In some embodiments, the processor may control the device 200 to fly along a predetermined route and, in some embodiments, the processor may determine a route as the device 200 is flying based on detected information or based on instructions from a remote device.

Referring to FIG. 2B, another exemplary air monitoring device 260 is shown. The device 260 includes a plurality of propellers 262 that are each powered by one or more motor 264. The device 260 further includes a main body 266 that includes a frame 268 and a material 269. The material 269 may be airtight such that the frame 268 and material 269 define an air proof volume in which a gas may be stored. In some embodiments, the gas may be lighter than air. In some embodiments, the frame 268 may include a lightweight material such as a carbon fiber composite, aluminum, or the like. The material 269 may include rubber, Mylar, or the like. In some embodiments, the airproof material may be expandable such that a total size of the main body 266 expands as gas is released into the volume. In some embodiments, the device 260 may include a cartridge (not shown) for releasing gas into the volume.

The main body 266 may be designed such that the material 269 forms one or more surfaces 272 upon which images may be displayed. For example, the surfaces 272 may include a display technology, such as LCD displays or e-ink displays. In some embodiments, the surfaces 272 may be transparent or translucent. In that regard, a projector 270 may project images 271 onto the surfaces 272 such that the images 271 are viewable by observers of the device 260.

The device 260 may further include one or more electrical components to 76 which may include a processor, network access device, or the like which may be controlled to transmit data and receive data from a remote device and/or to control operation of the device 260.

The device 260 may further include one or more sensor 274 such as a camera, an ultrasonic sensor, a radar sensor, a LIDAR sensor, or the like.

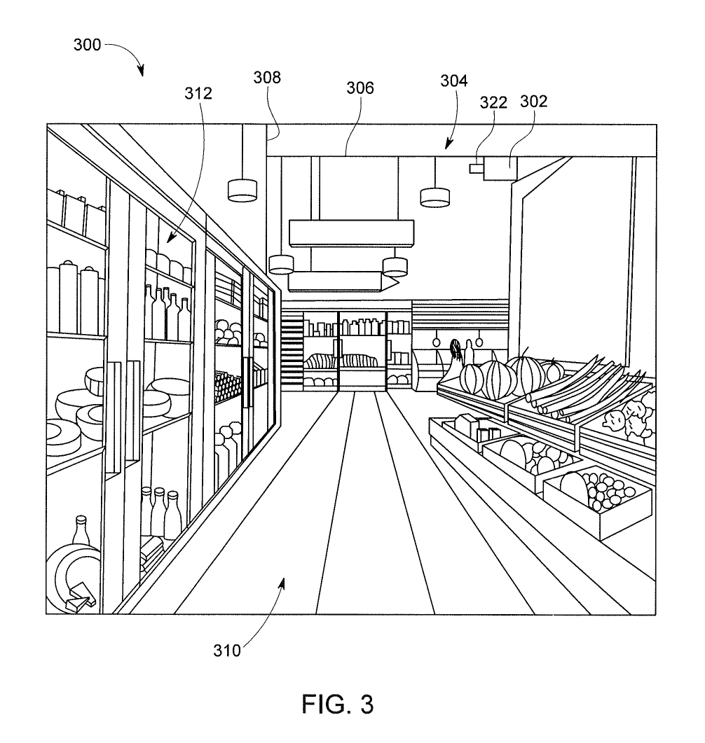

Turning now to FIG. 3, a system 300 for air monitoring is shown. The system 300 may include an air monitoring device 302 that includes a camera 322. The system 300 may further include a network of wires or cables 304 including a first wire or cable 306 and a second wire or cable 308. The device 302 may be supported by the network of wires or cables 304. In some embodiments, the device 302 may receive an electrical charge from the network of wires or cables 304. In some embodiments, the device 302 may communicate with a remote device by transmitting and receiving signals via the network of wires or cables 304.

The system 300 may be implemented, for example, in a store 310. The store 310 may include multiple shelves 312 oriented at different heights. The device 302 may be capable of adjusting its altitude relative to the shelves 312 in order to allow the camera 322 to detect data at multiple heights. In some embodiments, the device 302 may adjust the orientation and/or focus of the camera 322 to cause the camera 322 to detect data corresponding to each of the shelves 312 individually, or all of the shelves 312 in one location simultaneously.

In some embodiments, the device 302 may be designed to remain above the shelves 312 so as to remain out of the way of customers. This may reduce the likelihood of contact with customers which may result in injury to customers or damage to the device 302.

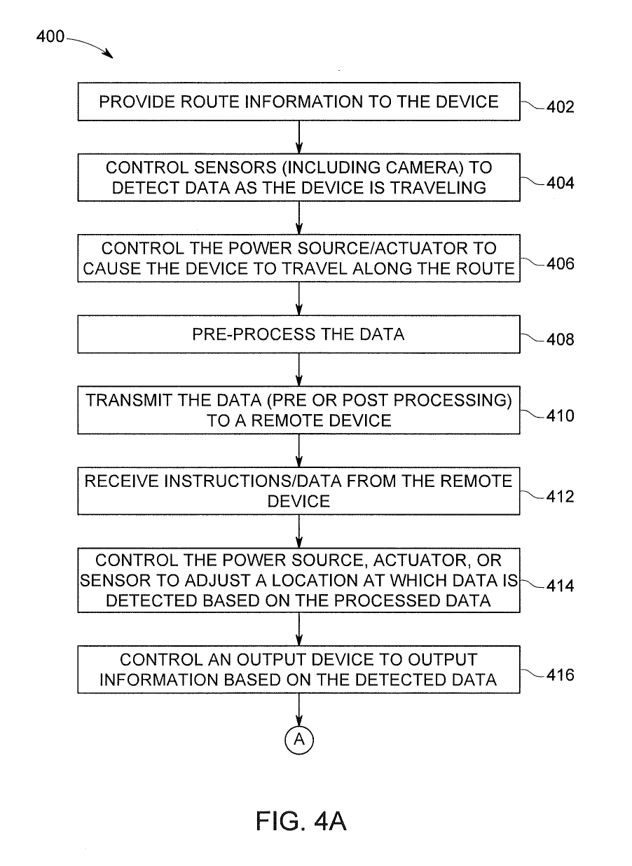

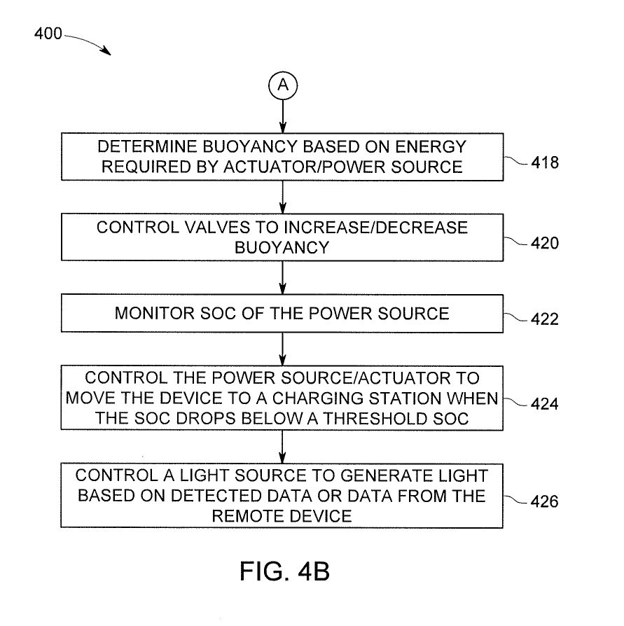

Turning now to FIGS. 4A and 4B, a method 400 may be used by an air monitoring system such as the air monitoring system 100 of FIG. 1 or the air monitoring system 300 of FIG. 3.

In block 402, route information may be provided to an air monitoring device. For example, the route information may be provided from a remote device or may be programmed directly into the device. In some embodiments, no route information may be provided to the air monitoring device and the device may determine its own route based on detected data or based on an area to be monitored. In some embodiments, the device may be provided with a predetermined area to be covered and a processor of the device (or a remote device) may determine a route in order to cover as much of the predetermined area as possible as quickly as possible.

In block 404, the processor of the device may control sensors to detect data as the device is traveling along the route (or traveling within the predetermined area). For example, the processor of the device may control a camera to detect image data. In some embodiments, the processor may control an actuator coupled to the camera to reorient the camera as the device is traveling in order to maximize an amount of image data detected by the camera. In some embodiments, the processor of the device may control a power source or actuator to change the location of the device to provide the sensors with a new vantage point. For example, the processor of the device may control the power source or actuator to change the location of the device to increase an amount of data detected by the sensors.

In block 406, the processor may control the power source and/or actuator to cause the device to travel along the predetermined route, or to travel within the predetermined area. In some embodiments, the device may be mechanically coupled to a wire or cable, or network of wires or cables. In that regard, the processor may control the power source and/or actuator to travel along the wire or cable or network of wires or cables.

In block 408, a processor of the device may preprocess the data. For example, the processor of the device may process the detected data to identify outliers, may process the data to compress a total size of the data, may perform an artificial intelligence algorithm on the data, may analyze the detected data to identify situations (such as empty shelves or hazards), or the like.

In block 410, the processor may control the network access device to transmit the data (either the raw data or the preprocessed data) to a remote device. The remote device may, for example, be part of an edge network capable of performing an artificial intelligence algorithm. In that regard, the remote device may take the received data and may analyze the received data to identify items of interest, such as whether shelves require restocking, whether a hazard exists at a certain location, or the like.

In block 412, the processor may receive instructions or data from the remote device via the network access device. The processor may receive instructions to output certain information via a display or speaker. For example, the remote device may identify that a shopper having certain characteristics is present in the environment of the device, and may instruct the device to output data directed to the characteristics of the shopper.

In block 414, the processor may control one or more of the power source, the actuator, or one or more sensor to adjust a location of data collection based on the processed data. For example, the processor or the remote device may identify that data, such as image data, has not been collected for a certain area in the environment of the device. In that regard, the processor may control one or more of the power source, the actuator, an actuator coupled to a camera, or focus of the camera to cause the camera to detect data corresponding to the certain area.

In block 416, the processor may control the output device to output information based on the detected data. For example, the information may include advertisements, warnings, or the like.

In block 418, the processor may determine a current buoyancy of the device. For example, the processor may determine the current buoyancy of the device based on a detected altitude of the device, based on an amount of power required of the actuator or power source to move the device or to cause the device to remain at a constant altitude, or the like.

In block 420, the processor may control valves to increase or decrease the buoyancy of the device. For example, it may be desirable for the device to be relatively buoyant neutral in air (i.e., for the device to not float or sink relative to its altitude) due to decreased energy usage when the device is relatively buoyant neutral. For example, if the device requires a significant amount of power to remain elevated then the processor may control a cartridge valve to allow compressed gas to be released into a volume of the device to increase buoyancy of the device. As another example, if the device is rising in altitude without the actuator causing such rise, the processor may control a volume valve to release gas from the volume to decrease the buoyancy of the device.

In block 422, the processor may monitor the state of charge (SOC) of the power source or the battery.

In block 424, when the SOC drops below a threshold SOC, the processor may control at least one of the power source or the actuator to move the device to a charging station and to orient the device such that a power port can receive power from the charging station. The threshold SOC may correspond, for example, to a SOC below which the device may be incapable of reaching the charging station.

In block 426, the processor may control a light source of the device to generate light based on detected data or based on instructions from the remote device. For example, if the data indicates that the ambient light in the environment of the device drops below a threshold amount of light then the processor may control the light source to generate light in order to illuminate the environment.

Advantages, benefits, improvements, and solutions, etc. have been described herein with regard to specific embodiments. Furthermore, connecting lines shown in the various figures contained herein are intended to represent exemplary functional relationships and/or physical couplings between the various elements. It should be noted that many additional and/or alternative functional relationships or physical connections may be present in a practical system. However, the advantages, benefits, improvements, solutions, etc., and any elements that may cause any advantage, benefit, improvement, solution, etc. to occur or become more pronounced are not to be construed as critical, essential, or required elements or features of this disclosure.

The scope of this disclosure is accordingly to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one, and that reference to an item in the singular may also include the item in the plural, and vice-versa. All ranges and ratio limits disclosed herein may be combined.

Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C. Different cross-hatching may be used throughout the figures to denote different parts, but not necessarily to denote the same or different materials. Like depictions and numerals also generally represent like elements.

The steps recited in any of the method or process descriptions may be executed in any order and are not necessarily limited to the order presented. Furthermore, any reference to singular elements, embodiments, and/or steps includes plurals thereof, and any reference to more than one element, embodiment, and/or step may include a singular one thereof. Elements and steps in the figures are illustrated for simplicity and clarity and have not necessarily been rendered according to any particular sequence. For example, steps that may be performed concurrently or in different order are only illustrated in the figures to help to improve understanding of embodiments of the present, representative disclosure.

Any reference to attached, connected, fixed, or the like may include full, partial, permanent, removable, temporary and/or any other possible attachment option. Additionally, any reference to without contact (or similar phrases) may also include reduced contact or minimal contact. Surface shading lines may be used throughout the figures to denote different areas or parts, but not necessarily to denote the same or different materials. In some cases, reference coordinates may or may not be specific to each figure.

Apparatus, methods, and systems are provided herein. In the detailed description herein, references to “one embodiment,” “an embodiment,” “various embodiments,” etc., indicate that the embodiment described may include a particular characteristic, feature, or structure, but every embodiment may not necessarily include this particular characteristic, feature, or structure. Moreover, such phrases may not necessarily refer to the same embodiment. Further, when a particular characteristic, feature, or structure is described in connection with an embodiment, it is submitted that it is within the knowledge of one skilled in the art to affect such characteristic, feature, or structure in connection with other embodiments, whether or not explicitly described. After reading the description, it will be apparent to one skilled in the relevant art(s) how to implement this disclosure in alternative embodiments.

Furthermore, no component, element, or method step in the present disclosure is intended to be dedicated to the public regardless of whether the component, element, or method step is explicitly recited in the claims. No claim element is intended to invoke 35 U.S.C. § 112(f) unless the element is expressly recited using the phrase “means for.” As used herein, the terms “comprises,” “comprising,” or any other variation thereof, are intended to cover a non-exclusive inclusion, such that an apparatus, article, method, or process that comprises a list of elements does not include only those elements, but it may also include other elements not expressly listed or inherent to such apparatus, article, method, or process.

What is claimed is:

1. An air monitoring device, comprising:
a main body defining a volume for receiving a gas and configured to move above a ground surface;
a camera configured to detect image data corresponding to a surrounding environment of the main body;
a power source configured to generate mechanical power to propel the main body through the surrounding environment;
a network access device configured to communicate with a remote device;
a display coupled to the main body and configured to display information; and
a processor configured to receive the image data, to cause the network access device to transmit the image data or processed data corresponding to the image data to the remote device, and to control the information displayed by the display.

2. The air monitoring device of claim 1 wherein the display includes at least one of a projector configured to project the information onto a surface of the main body, a liquid crystal display, or an e-ink display.

3. The air monitoring device of claim 2 wherein the projector is located on an interior of the main body and is configured to project the information on a surface of the main body.

4. The air monitoring device of claim 1 wherein the processor is further configured to adjust the information displayed by the display based on at least one of a current location of the main body or based on the image data.

5. The air monitoring device of claim 1 wherein the processor is further configured to control the power source to cause the main body to travel at least one of along a route or to a specific location to cause the camera to detect the image data at least one of along the route or at the specific location.

6. The air monitoring device of claim 1 wherein the processor is further configured to control at least one of the power source or the camera to cause the camera to detect the image data that corresponds to shelves of a store.

7. The air monitoring device of claim 6 wherein the processor is further configured to analyze the image data to identify whether one or more product on a shelf needs restocking.

8. The air monitoring device of claim 1 further comprising a cartridge configured to store compressed gas, and a cartridge valve located between the cartridge and the volume defined by the main body, wherein the processor is further configured to control the cartridge valve to allow the compressed gas to flow from the cartridge to the volume to increase buoyancy of the main body.

9. The air monitoring device of claim 8 further comprising a volume valve coupled to the volume, wherein the processor is further configured to control the volume valve to allow the compressed gas to exit the volume to decrease buoyancy of the main body.

10. The air monitoring device of claim 1 further comprising at least one propeller configured to maneuver the main body through the surrounding environment.

11. The air monitoring device of claim 10 further comprising a location sensor configured to detect a current location of the main body, wherein the processor is further configured to control the at least one propeller to maneuver the main body through the surrounding environment based on the current location of the main body.

12. The air monitoring device of claim 10 wherein the processor is further configured to determine a current location of the main body based on the image data, and to control the at least one propeller to maneuver the main body through the surrounding environment based on the current location of the main body.

13. The air monitoring device of claim 10 further comprising a battery configured to store electrical power usable by the power source, wherein the processor is further configured to monitor a state of charge (SOC) of the battery and to control the at least one propeller to maneuver the main body to a charging station to charge the battery in response to the SOC of the battery reaching or dropping below a predetermined SOC threshold.

14. The air monitoring device of claim 1 further comprising a microphone configured to detect audio data corresponding to the surrounding environment, wherein the processor is further configured to cause the network access device to transmit the audio data or additional processed data corresponding to the audio data to the remote device.

15. The air monitoring device of claim 1 further comprising a sensor configured to detect sensor data corresponding to at least one of a fire, gas, or a chemical, wherein the processor is further configured to cause the network access device to transmit the sensor data to the remote device.

16. An air monitoring device, comprising:
a main body defining a volume for receiving a gas and configured to move above a ground surface;
a cartridge configured to store compressed gas;
a cartridge valve located between the cartridge and the volume defined by the main body;
a camera configured to detect image data corresponding to a surrounding environment of the main body;
a network access device configured to communicate with a remote device; and
a processor configured to receive the image data, to cause the network access device to transmit the image data or processed data corresponding to the image data to the remote device, and to control the cartridge valve to allow the compressed gas to flow from the cartridge to the volume to increase buoyancy of the main body.

17. The air monitoring device of claim 16 further comprising a volume valve coupled to the volume, wherein the processor is further configured to control the volume valve to allow the compressed gas to exit the volume to decrease buoyancy of the main body.

18. A system for air monitoring, comprising:
at least one wire or cable suspended above a ground surface; and
an air monitoring device having:
a main body defining a volume for receiving a gas and configured to be coupled to the at least one wire or cable,
a camera configured to detect image data corresponding to a surrounding environment of the main body,
an actuator configured to move the main body along the at least one wire or cable,
a network access device configured to communicate with a remote device, and
a processor configured to receive the image data and to cause the network access device to transmit the image data or processed data corresponding to the image data to the remote device.

19. The system of claim 18 wherein the actuator is further configured to receive electrical power from the at least one wire or cable.

20. The system of claim 18 wherein the at least one wire or cable includes a network of wires or cables, and the processor is further configured to control the actuator to move the main body along a predetermined path along the network of wires or cables.
